(19) United States
(12) Patent Application Publication
(10) Pub. No.: US 2025/0362493 A1
(43) Pub. Date: Nov. 27, 2025

(54) OPTICAL SCANNING APPARATUS AND IMAGE FORMING APPARATUS INCLUDING OPTICAL SCANNING APPARATUS

(71) Applicant: CANON KABUSHIKI KAISHA, Tokyo (JP)

(72) Inventors: TOSHIFUMI CHIDA, Tochigi (JP); KAZUMI KIMURA, Saitama (JP)

(21) Appl. No.: 19/215,079

(22) Filed: May 21, 2025

(30) Foreign Application Priority Data
May 27, 2024 (JP) 2024-085798

(51) Int. Cl. G02B 26/12; G03G 15/043

(52) U.S. Cl. CPC G02B 26/122; G02B 26/124; G02B 26/125; G03G 15/0435

(57) ABSTRACT

A scanning apparatus includes a deflector configured to deflect a light flux from a light source to scan a surface with the light flux in a main-scanning direction, and an optical system configured to guide the light flux deflected by the deflector to the surface to be scanned, wherein a scanning speed is a variable speed, and wherein a predetermined inequality is satisfied.

### BACKGROUND

### Technical Field

The aspect of the embodiments relates to an optical scanning apparatus, and is suitable for an image forming apparatus, such as a laser beam printer (LBP), a digital copy machine, and a multi-function printer.

### Description of the Related Art

Japanese Patent Application Laid-Open No. 2017-016144 discusses an optical scanning apparatus configured to perform optical scanning a surface to be scanned at non-uniform speed using an imaging optical system for guiding a light flux from a deflector to the surface.

### SUMMARY

According to an aspect of the present disclosure, a scanning apparatus includes a deflector configured to deflect a light flux from a light source to scan a surface with the light flux in a main-scanning direction, and a system configured to guide the light flux deflected by the deflector to the surface to be scanned, wherein a scanning speed is a variable speed, and wherein a predetermined inequality is satisfied:

0.70≤|Y|/|Ymax|<1.00,

where on the surface to be scanned, |Ymax| is an absolute value of a maximum off-axis image height and |Y| is an intermediate image height at which the scanning speed is maximum.

Further features of the present disclosure will become apparent from the following description of exemplary embodiments with reference to the attached drawings.

### BRIEF DESCRIPTION OF THE DRAWINGS

FIG. 1 is a schematic diagram illustrating a main section of an optical scanning apparatus according to a first example.

FIG. 2 is a graph indicating a curvature of an imaging optical element according to the present example.

FIG. 3 is a schematic diagram illustrating an edge thickness.

FIG. 4 illustrates a power ratio relative to an on-axis power according to the present example.

FIG. 5 illustrates an optical scanning ratio with respect to an on-axis optical scanning according to the present example.

FIG. 6 illustrates a curvature of an imaging optical element according to a second example.

FIG. 7 illustrates a power ratio with respect to an on-axis power according to the present example.

FIG. 8 illustrates an optical scanning ratio with respect to an on-axis optical scanning according to the present example.

FIG. 9 illustrates a curvature of an imaging optical element according to a third example.

FIG. 10 illustrates a power ratio with respect to an on-axis power according to according to the present example.

FIG. 11 illustrates an optical scanning ratio with respect to an on-axis optical scanning according to the present example.

FIG. 12 illustrates an image forming apparatus.

### DESCRIPTION OF THE EMBODIMENTS

Some exemplary embodiments will be described with reference to the drawings. In each drawing, a scale can be different from the actual scale for the sake of convenience. Further, in each drawing, an identical member is denoted by an identical reference number and the redundant description will be omitted.

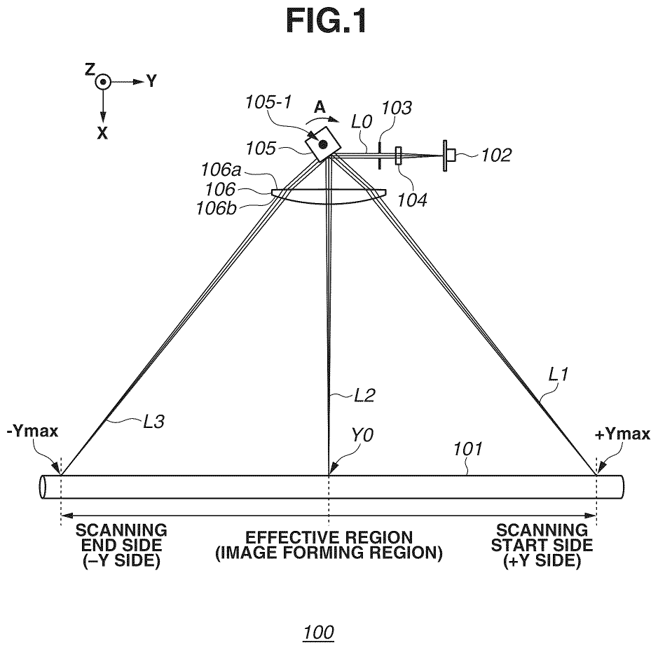

FIG. 1 is a schematic view illustrating a main-scanning cross section (an XY cross section) of an optical scanning apparatus 100 according to an exemplary embodiment. The optical scanning apparatus 100 includes a deflector 105 that deflects a light flux from a light source 102 and scans a to-be-scanned surface 101 with the light flux in a main-scanning direction (a Y direction), and an imaging optical system 106 that guides the light flux deflected by the deflector 105 to the to-be-scanned surface 101.

In the following description, it is on the assumption that the optical axis of the imaging optical system 106 is an X axis, and a traveling direction of the light flux from the imaging optical system 106 on the optical axis is defined as a +X direction. The main-scanning direction (the Y direction) is a direction perpendicular to the rotation axis of the deflector 105 and the optical axis direction (the X direction) of the imaging optical system 106 (the direction in which the to-be-scanned surface 101 is scanned), and a scanning start side and a scanning end side of the to-be-scanned surface 101 with respect to the optical axis direction (the X axis) are defined as a +Y side and a −Y side, respectively. A sub-scanning direction (a Z direction) is a direction parallel to the rotation axis of the deflector 105. The main-scanning cross section (the XY cross section) includes the optical axis (the X axis) and is parallel to the main-scanning direction (i.e., a cross section perpendicular to the sub-scanning direction). A sub-scanning cross section (a ZX cross section) is parallel to the optical axis (the X axis) and the sub-scanning direction (i.e., a cross section perpendicular to the main-scanning direction).

Additionally, an image height on the optical axis of the imaging optical system 106 at the to-be-scanned surface 101 (an intersection between the to-be-scanned surface 101 and the optical axis) is defined as an on-axis image height Y0, and image heights other than the on-axis image height as off-axis image heights. Among the off-axis image heights, image heights corresponding to the respective ends of an effective region (an image forming region) on the to-be-scanned surface 101 are defined as maximum off-axis image heights +Ymax and −Ymax, respectively. Image heights between the on-axis image height Y0 and each of the maximum off-axis image heights ±Ymax are defined as intermediate image heights. The on-axis image height Y0 (Y=0) is at the center of the effective region on the to-be-scanned surface 101. The maximum off-axis image height on the scanning start side relative to the on-axis image height Y0 is defined as the +Ymax, and the maximum off-axis image height on the scanning end side relative to the on-axis image height Y0 as the −Ymax.

FIG. 1 illustrates, among light fluxes from the light source 102, maximum off-axis light fluxes L1 and L3 that respectively reach the maximum off-axis image height +Ymax (the scanning start position) and the maximum off-axis image height-Ymax (the scanning end position), and an on-axis light flux L2 that reaches the on-axis image height Y0 (the center position), and other light fluxes are omitted. Regarding the light fluxes L1, L2, and L3 each, a principal ray and marginal rays are illustrated, and other light rays are omitted.

A general optical scanning apparatus using a constant-speed scanning method has a configuration in which, when light rays emitted from a light source at regular intervals are deflected by a deflector rotating at a constant speed, the light rays reach the to-be-scanned surface at regular intervals. In other word, an imaging optical system in the optical scanning apparatus using the constant-speed scanning method has distortion aberration (fθ characteristic) such that a rotation angle of the deflector (a scanning angle) and an image height on the scanned surface in the main-scanning direction on the scanned surface are in a proportional relationship, allowing a light flux passing through the imaging optical system 106 to scan the to-be-scanned surface at a constant speed. In this case, to form a good image (spot) in the effective region on the scanned surface, it is necessary to properly correct a field curvature of the imaging optical system across the entire effective region.

However, to maintain a constant speed of optical scanning while the field curvature is properly corrected, it is necessary to vary the shape of each optical surface in the main-scanning cross section in the imaging optical system between on the optical axis and off the optical axis. Furthermore, if an imaging optical element constituting the imaging optical system is disposed near the deflector to downsize the optical scanning apparatus, the shape of each optical surface becomes a steep shape. In this case, each imaging optical element increases in thickness as comatic aberration increases, which makes it difficult to sufficiently downsize the entire optical scanning apparatus.

To address this, the imaging optical system 106 according to the present exemplary embodiment has a configuration in which a light flux through the imaging optical system 106 does not travel at a constant speed on the to-be-scanned surface 101 (i.e., scanning is performed at non-uniform speed). In other words, the imaging optical system 106 has a partial magnification (a local magnification in the main-scanning direction) such that an arrival position of light rays on the to-be-scanned surface 101 shifts from an arrival position when scanning is performed at a constant speed. Thus, the optical scanning apparatus 100 according to the present exemplary embodiment employs a variable-speed scanning method in which the scanning speed to perform scanning with a light flux varies between an off-axis image height and an off-axis image height, which can reduce a distance between the imaging optical system 106 and both the deflector 105 and the to-be-scanned surface 101 while imaging performance is maintained. Furthermore, since it is no longer necessary to design the power of the imaging optical system 106 for constant-speed scanning, increase in thickness of the imaging optical element that constitutes the imaging optical system 106 can be reduced. This makes it possible downsize the optical scanning apparatus 100.

If the variable-speed scanning method is employed, a scanning position at an off-axis image height (a scanning distance per unit time) is elongated according to the different amount of a partial magnification at an off-axis image height relative to a partial magnification at the on-axis image height (a partial magnification difference). If the to-be-scanned surface 101 is scanned without considering this partial magnification difference, that may lead to degradation of an image (deterioration of print performance) formed on the to-be-scanned surface 101. Thus, a not-illustrated control unit desirably controls light emission from the light source 102 to prevent such deterioration of print performance. Specifically, the control unit desirably controls at least one of a modulation timing (a light emission timing) of the light source 102 and a modulation time (a light emission time) of the light source 102 based on the partial magnification difference to electrically correct at least one of a scanning position and a scanning time on the to-be-scanned surface 101. This makes it possible to correct the partial magnification difference and the image degradation, providing good print performance similar to when fθ characteristic is satisfied. In this case, to achieve better print performance, the partial magnification difference in the imaging optical system 106 desirably falls within 2% at all image heights.

With the constant-speed scanning method employed, it is necessary to intentionally generate distortion aberration by making the power (a refractive power) at the edges of the imaging optical system larger than that at the central portion of the imaging optical system so that light ray arrival positions in the proximity of the maximum off-axis image height on the scanned surface are formed at regular intervals. On the other hand, with the variable-speed scanning method employed, it is not necessary to increase the power at the edges of the imaging optical system as in the constant-speed scanning method. Thus, the thickness of the edges of the imaging optical element that constitutes the imaging optical system can be reduced as compared with the case of the constant-speed scanning method. However, if the power at the edges of the imaging optical system is simply reduced, the scanning speed will monotonically increase from the on-axis image height to the maximum off-axis image heights, resulting in an increase in a light flux diameter (a spot diameter) in the proximity of the maximum off-axis image heights, which may lead to poor print performance. Further, if an attempt is made to thin the entire imaging optical element while imaging performance is maintained, the thickness of the edges (edge portions) of the effective region of the imaging optical element becomes too thin, which may cause molding defect in the imaging optical element.

To address this, in the optical scanning apparatus 100 according to the present exemplary embodiment, the imaging optical system 106 is configured so that the scanning speed is maximized at an intermediate image height between the on-axis image height and the maximum off-axis image heights on the to-be-scanned surface 101. Specifically, when an absolute value of the maximum off-axis image heights on the to-be-scanned surface 101 is |Ymax| and the intermediate image height with the maximum scanning speed is |Y|, the following inequality (1) is satisfied.

$$0.7 \leq \vert Y \vert / \vert Ymax \vert < 1. \qquad ( 1 )$$

If the inequality (1) is satisfied and the scanning speed relative to an image height on the to-be-scanned surface 101 is represented in a graph, the graph has local maximum values at the intermediate image heights ±Y. This makes it possible to maintain a sufficient thickness of the edges of the imaging optical element while thinning the entire imaging optical element constituting the imaging optical system 106. If a value is smaller than the lower limit of the inequality (1), the power from the central portion of the imaging optical element to the intermediate portion of the imaging optical element needs to be increased. In this case, to achieve good print performance across the entire effective region, it is necessary to significantly thin the edges of the imaging optical element, which makes it difficult to manufacture the imaging optical element. If a value exceeds the upper limit of the inequality (1), the scanning speed monotonically increases from the on-axis image height Y0 to the maximum off-axis image height Ymax, leading to increase in a spot diameter in the proximity of the maximum off-axis image height. This makes it difficult to provide good print performance.

Furthermore, the following inequality (1a) is satisfied, and the following inequality (1b) is satisfied.

$$0.72 \leq \vert Y \vert / \vert Ymax \vert \leq 0. 98 \qquad ( 1 a )$$

$$0.75 \leq \vert Y \vert / \vert Ymax \vert \leq 0.95 \qquad ( 1 b )$$

The imaging optical system 106 is desirably configured so that the scanning speed to scan the to-be-scanned surface 101 with a light flux at the maximum off-axis image heights ±Ymax is higher than the scanning speed to scan the to-be-scanned surface 101 with a light flux at the on-axis image height Y0. If the scanning speed at the maximum off-axis image heights ±Ymax is configured to be slower than the scanning speed at the on-axis image height Y0 while the inequality (1) is satisfied, it is necessary to either significantly reduce the scanning speed at the maximum off-axis image heights ±Ymax or increase the scanning speed at the on-axis image height Y0 up to almost the maximum scanning speed. This causes an excessively large change of the scanning speed in the proximity of the maximum off-axis image heights ±Ymax or an excessively small change of the scanning speed across the entire region of the to-be-scanned surface 101, resulting in poor print performance.

Additionally, the imaging optical system 106 is desirably configured so that the scanning speed to scan the to-be-scanned surface 101 with a light flux monotonically changes between the intermediate image heights ±Y and both the on-axis image height Y0 and the maximum off-axis image heights ±Ymax. Between the intermediate image heights ±Y and both the on-axis image height Y0 and the maximum off-axis image heights ±Ymax herein means between the intermediate image heights ±Y and the on-axis image height Y0, between the intermediate image height +Y and the maximum off-axis image height +Ymax on the scanning start side, and between the intermediate image height −Y and the maximum off-axis image height-Ymax on the scanning end side. Thus, when a scanning speed relative to an image height on the to-be-scanned surface 101 is represented in a graph, the graph desirably has a local minimum value at the on-axis image height Y0 alone and local maximum values at the intermediate image height +Y on the scanning start side and the intermediate image height −Y on the scanning end side alone.

This configuration makes it possible to prevent the scanning speed from changing excessively between different image heights, thus maintain good print performance. In this case, the imaging optical system 106 is configured so that the scanning speed to scan the to-be-scanned surface 101 with a light flux monotonically increases from the on-axis image height Y0 to the intermediate image heights ±Y, and monotonically decreases from the intermediate image heights ±Y to the maximum off-axis image heights ±Ymax. This configuration makes it possible to prevent poor print performance for a reason similar to the above-described reason.

When the maximum value (the local maximum value) of the scanning speed to scan the to-be-scanned surface 101 with a light flux is Vmax and the scanning speed to perform scanning with a light flux at the maximum off-axis image heights ±Ymax is Ve, the optical scanning apparatus 100 according to the present exemplary embodiment desirably satisfies the following inequality (2).

$$0.85 \leq Ve / Vmax < 1 \text{.00} \qquad ( 2 )$$

If a value is smaller than the lower limit value of the inequality (2), it is necessary to significantly increase the power at the edges of the imaging optical element. As a result, the thickness of the edges (an edge thickness) in the effective region of the imaging optical element become too thin, and molding defect may occur at the time of manufacturing. If a value exceeds the upper limit of the inequality (2), the scanning speed to scan the to-be-scanned surface 101 with a light flux monotonically increases from the on-axis image height Y0 to the maximum off-axis image heights ±Ymax. This can cause increase in a spot diameter in the proximity of the maximum off-axis image heights, making it difficult to provide good print performance.

Furthermore, the following inequality (2a) is desirably satisfied, and the following inequality (2b) is more desirably satisfied.

$$0.88 \leq Ve / Vmax \leq 0.98 \qquad ( 2 a )$$

$$0.9 \leq Ve / Vmax \leq 0.96 \qquad ( 2 b )$$

When the minimum value (the local minimum value) of the scanning speed to scan the to-be-scanned surface 101 with a light flux is Vmin, the optical scanning apparatus 100 according to the present exemplary embodiment desirably satisfies the following inequality (3).

$$1.1 \leq Vmax / Vmin < 1 \text{.40} \qquad ( 3 )$$

If a value is smaller than the lower limit of the inequality (3), the difference between the minimum value and maximum value of the scanning speed becomes too small, approaching the constant-speed scanning method. This may make it difficult to thin the imaging optical element. If a value exceeds the upper limit of the inequality (3), the maximum value of the scanning speed becomes too large, which may make it difficult to prevent increase in a spot diameter in the proximity of the maximum off-axis image heights.

Furthermore, the following inequality (3a) is desirably satisfied, and the following inequality (3b) is more desirably satisfied.

$$1.15 \leq Vmax / Vmin < 1 \text{.35} \qquad ( 3 a )$$

$$0.2 \leq Vmax / Vmin < 1 \text{.30} \qquad ( 3 b )$$

When the thickness of the imaging optical element on the optical axis is Do and the thickness (the edge thickness) of the imaging optical element at a position through which a maximum off-axis ray passes is Dc, the optical scanning apparatus 100 according to the present exemplary embodiment desirably satisfies the following inequality (4).

$$0.46 \leq Dc / Do \leq 0 \text{.60} \qquad ( 4 )$$

If a value is smaller than the lower limit of the inequality (4), the edge thickness of the imaging optical element becomes too thin. This may cause molding defect in the imaging optical element. If a value exceeds the upper limit of the inequality (4), thinning the entire imaging optical element may be difficult.

Furthermore, the following inequality (4a) is desirably satisfied, and the following inequality (4b) is desirably satisfied.

$$0.47 \leq Dc / Do \leq 0 \text{.58} \qquad ( 4 a )$$

$$0.48 \leq Dc / Do \leq 0 \text{.55} \qquad ( 4 b )$$

Some examples based on the above-described exemplary embodiment will now be described in detail.

A first example will be described. An optical scanning apparatus 100 according to the present example is described. Since the optical scanning apparatus 100 according to the present example has a configuration that is equivalent to the configuration of the optical scanning apparatus 100 according to the above-described exemplary embodiment, the redundant description will be omitted.

As illustrated in FIG. 1, the optical scanning apparatus 100 according to the present example includes the light source 102, a diaphragm 103 that regulates the light flux from the light source 102, an incidence optical system 104 that guides the light flux from the light source 102 to the deflector 105, the above-described deflector 105, and the above-described imaging optical system 106. In the optical scanning apparatus 100, the light flux emitted from the light source 102 passes through an aperture of the diaphragm 103 and is guided by the incidence optical system 104 to the deflection surface of the deflector 105. The light source 102, the diaphragm 103, and the incidence optical system 104 are not necessarily included in the optical scanning apparatus 100, and can, for example, be configured as an external illumination apparatus.

The light source 102 includes a substrate and a light emitting element (a light emitting point) provided on the substrate. The light source 102, for example, can be a semiconductor laser and can have one or a plurality of light emitting points. The light source 102 according to the present example is an edge emitting laser and has a configuration in which a single light emitting point is provided on the substrate. If the light source 102 is provided with a plurality of light emitting points, it is desirable that a vertical cavity surface emitting laser (VCSEL) be employed. Alternatively, a light emitting diode (LED) can be used as the light source 102. In the present example, it is on the assumption that the light source 102 emits a light flux having a wavelength of 780 nm, but a light source that emits a light flux having another wavelength can be used.

The diaphragm 103 blocks a part of the light flux from the light source 102 to shape the light flux to be reached to the deflector 105 and regulate a light quantity. Of the light flux through the aperture provided in the diaphragm, the light ray that passes through the center of the aperture is a principal ray and light rays that pass at the periphery of the aperture are marginal rays. In the present example, a rectangular diaphragm with a rectangular aperture is used as the diaphragm 103, but the shape of the aperture is not limited thereto. For example, an ellipse diaphragm with an ellipse aperture or a circular diaphragm with a circular aperture can be used as the diaphragm 103.

The incidence optical system 104 according to the present example includes an anamorphic lens as an optical element (an incidence optical element) that converts the convergence of a light flux from the light source 102. The anamorphic lens is a lens that has different powers (refractive strengths) in the main-scanning cross section and in the sub-scanning cross section. The anamorphic lens according to the present example converts a diverged light flux from the light source 102 into a substantially parallel light flux or a substantially convergent light flux in the main-scanning cross section and focuses the light flux onto the deflection surface of the deflector 105 in the sub-scanning cross section.

It is desirable for the anamorphic lens in the incidence optical system 104 to be disposed closer to the deflector 105 (the −Y side) than the front principal surface of the anamorphic lens. This arrangement causes the light flux emitted from the anamorphic lens to be a substantially convergent light flux in the main-scanning cross section, which makes it easier to thin the imaging optical element that constitutes the imaging optical system 106. While the incidence optical system 104 according to the present example consists of a single optical element (an anamorphic lens), a plurality of optical elements can be included. For example, the incidence optical system 104 may consist of two optical elements, a collimator lens and a cylindrical lens, to share the conversion of convergence in the main-scanning cross section and the light condensing in the sub-scanning cross section with each other.

The deflector 105 is rotated at a constant speed in the direction of an arrow A in FIG. 1 by a not-illustrated driving unit (e.g., a motor), and deflects the light flux from the incidence optical system 104 with a plurality of deflection surfaces (reflection surfaces). The light flux from the deflector 105 is used to scan the effective region of the to-be-scanned surface 101 from the scanning start side (the +Y side) to the scanning end side (the −Y side) via an incident surface 106a (an optical surface to the deflector 105 side) of the imaging optical element and an exit surface 106b (an optical surface on the to-be-scanned surface 101 side) of the imaging optical element in that order. When the optical scanning apparatus 100 is applied to an image forming apparatus described below, the effective region of the to-be-scanned surface 101 is an image forming region (a region to be printed). In the present example, a rotary polygon mirror (a polygon mirror) having four deflection surfaces is used as the deflector 105, but the number of deflection surfaces is not limited to four. A pivot mirror having one or two deflection surfaces configured to pivot can be used in substitution for the rotary polygon mirror. As the pivot mirror, for example, a micro electro mechanical systems (MEMS) mirror can be used.

The imaging optical system 106 according to the present example focuses the light flux deflected by the deflector 105 onto the to-be-scanned surface 101 in both the main-scanning cross section and the sub-scanning cross section to form an image of the light-emitting point from the light source 102 on the to-be-scanned surface 101 or in the proximity of the to-be-scanned surface 101. In this case, the imaging optical system 106 is disposed so that the deflection surface or the proximity of the deflection surface and the to-be-scanned surface 101 or the proximity of the to-be-scanned surface 101 have a conjugate relationship in the sub-scanning cross section. This makes it possible to reduce a position shift in scanning (a deflection surface tilt correction) on the to-be-scanned surface 101 when the deflection surface is inclined due to placement error or another cause.

While the imaging optical system 106 according to the present example consists of a single imaging optical element, a plurality of imaging optical elements can be included. However, to downsize the entire optical scanning apparatus 100, it is desirable that the imaging optical system 106 consist of a single imaging optical element as in the present example. The imaging optical element according to the present example is an anamorphic lens (a toric lens) that has different powers in the main-scanning cross section and in the sub-scanning cross section.

Since the anamorphic lens constituting the incidence optical system 104 and the imaging optical system 106 according to the present example is a plastic molded lens formed by injection of resin material, allowing significant cost reduction as compared with cases of using glass lenses. Additionally, using plastic molded lenses makes it easier to form a diffraction surface or an aspheric surface, which increases productivity and optical performance. However, glass lenses can be used as lenses constituting the incidence optical system 104 and the imaging optical system 106 as necessary. Each anamorphic lens according to the present example consists of a resin material called K22R (Zeonex®) manufactured by Zeon Corporation, but a resin material is not limited thereto.

A shape (a generatrix shape) of the incident surface 106a and exit surface 106b of the imaging optical element according to the present example in the main-scanning cross section including surface vertices is expressed by the following expression (an aspheric equation). Here, the intersection of each optical surface (lens surface) vertex and each optical axis is set as the origin with the axis in the optical axis direction as an X axis, the axis orthogonal to the X axis in the main-scanning cross section as a Y axis, and the axis orthogonal to the X axis and the Y axis as a Z axis, forming a local coordinate system (distinguished from a global coordinate system illustrated in FIG. 1). Additionally, the generatrix shape on the scanning start side (the +Y side) and the generatrix shape on the scanning end side (the −Y side) are represented by different aspheric equations relative to the optical axis (the X axis).

$$X = \frac{\frac{{y}^{2}}{R}}{1 + \sqrt{( 1 + K ) {( \frac{y}{R} )}^{2}}} + {B}_{3} {y}^{3} + {B}_{4 s} {y}^{4} + {B}_{6 s} {y}^{6} + {B}_{8 s} {y}^{8} + {B}_{10 s} {y}^{10} + {B}_{12 s} {y}^{12} \qquad [ Expression 1 ]$$

$$X = \frac{\frac{{y}^{2}}{R}}{1 + \sqrt{( 1 + K ) {( \frac{y}{R} )}^{2}}} + {B}_{3} {y}^{3} + {B}_{4 e} {y}^{4} + {B}_{6 e} {y}^{6} + {B}_{8 e} {y}^{8} + {B}_{10 e} {y}^{10} + {B}_{12 e} {y}^{12} \qquad [ Expression 2 ]$$

In the expressions, R is a curvature radius (a generatrix radius of curvature, a meridional radius of curvature) on the optical axis in the main-scanning cross section, and K, B₃, B₄, B₆, B₈, B₁₀, and B₁₂ are each an aspheric coefficient in the main-scanning cross section.

A suffix s added to an aspheric coefficient B indicates the scanning start side (the +Y side), and a suffix e indicates the scanning end side (the −Y side). By differentiating numeric values of aspheric coefficients B₄ to B₁₂ between the scanning start side (the +Y side) and the scanning end side (the −Y side), the generatrix shapes can be made asymmetrical in the main scanning direction relative to the optical axis.

Additionally, a curvature radius r′ (a sagittal radius of curvature) in the sub-scanning section at each position (each image height) in the main scanning direction on each optical surface of the imaging optical system 106 according to the present example is expressed by the following expression (a continuous function). The following expressions are based on the assumption of the above-described local coordinate system and are expressed as aspheric expressions in which a sagittal radius-of-curvature on the scanning start side (the +Y side) and a sagittal radius-of-curvature on the scanning end side (the −Y side) are different from each other with respect to the optical axis (the X axis).

$${r}^{′} ( Y ) = r ( 1 + {\sum }_{i = 1}^{10} {E}_{is} {Y}^{i} ) \qquad [ Expression 3 ]$$

$${r}^{′} ( Y ) = r ( 1 + {\sum }_{i = 1}^{10} {E}_{ie} {Y}^{i} ) \qquad [ Expression 4 ]$$

In the above-expressions, r is a curvature radius on the optical axis in the sub-scanning cross section, and Eᵢ is the sagittal variation coefficient. A suffix s added to the sagittal variation coefficient Eᵢ indicates the scanning start side (the +Y side), and a suffix e indicates the scanning end side (the −Y side). The sagittal radius-of-curvature (a sagittal shape) of each optical surface is, in other words, a surface shape in a cross section perpendicular to the main-scanning cross section including a surface normal on the generatrix at each position in the main-scanning direction.

Table 1 shows specification values of the optical scanning apparatus 100 according to the present example. Each distance shown in Table 1 indicates a value on the optical axis of the incidence optical system 104 or the imaging optical system 106. While a distance between the deflector 105 and each component varies depending on a rotation angle of the deflector 105, Table 1 shows a distance to an intersection (an on-axis axis deflection point) between the principal ray of an on-axis light flux L2 and the deflection surface when the on-axis light flux L2 that reaches the to-be-scanned surface 101 at the on-axis image height Y0 is deflected. An “angle of an incident principal ray” indicates an angle formed between the principal ray of a light flux emitted from the incidence optical system 104 incident on the deflection surface and the optical axis of the imaging optical system 106. “Coordinates of the rotation center of the deflector” indicates coordinates (positions) of the rotation center (the rotation axis) of the deflector 105 with the on-axis deflection point serving as the point of origin. In the present example, maximum scanning angles and maximum off-axis image heights (effective scanning widths) are symmetrical with respect to the optical axis of the imaging optical system 106. Table 1 shows the values on one side with respect to the optical axis are positive, while the values on the other side with respect to the optical axis are negative.

TABLE 1
Specification values of optical scanning apparatus

| | | |
|---|---|---|
| Wavelength of light emitted from light source | (nm) | 780 |
| Distance from light-emitting point of light source to incident | (mm) | 0.5 |
| surface of incidence optical element | | |
| Thickness of incidence optical element | (mm) | 2 |
| Refractive index of incidence optical element | | 1.524 |
| Curvature radius of incident surface of incidence optical | (mm) | ∞ |
| element in main-scanning cross section | | |
| Curvature radius of incident surface of incidence optical | (mm) | ∞ |
| element in sub-scanning cross section | | |
| Curvature radius of exit surface of incidence optical element in | (mm) | −41.519 |
| main-scanning cross section | | |
| Curvature radius of exit surface of incidence optical element in | (mm) | 12.483 |
| sub-scanning cross section | | |
| Distance from exit surface of incidence optical element to | (mm) | 6.88 |
| diaphragm | | |
| Distance from diaphragm to on-axis deflection point of | (mm) | 19.79 |
| deflector | | |
| Distance from on-axis deflection point to incident surface of | (mm) | 13.8 |
| imaging optical element | | |
| Thickness of imaging optical element | (mm) | 5.4 |
| Refractive index of imaging optical element | | 1.524 |
| Distance from on-axis deflection point to to-be-scanned surface | (mm) | 128.6 |
| Focal length of imaging optical element (fθ coefficient on axis) | (mm/rad) | 109 |
| Maximum scanning angle | (deg) | ±25.5 |
| Maximum off-axis image height | (mm) | ±107 |
| Angle of incident principal ray in main-scanning cross section | (deg) | 90 |
| Radius of circumscribed circle in main-scanning cross section | (mm) | 20 |
| of deflector | | |
| Coordinate of rotation center (X) of deflector | (mm) | −5.89 |
| Coordinate of rotation center (Y) of deflector | (mm) | −4.29 |

Table 2 indicates a shape of each optical surface of the imaging optical element according to the present example. A suffix s added to both the “incident surface” and the “exit surface” indicates the scanning start side (the +Y side), and a suffix e added to both the “incident surface” and the “exit surface” indicates the scanning end side (the −Y side). Additionally, “.E±N” indicates “×10^{±}N”. As indicated in Table 2, the shapes of the incident surface and exit surface of the imaging optical element according to the present example are different from each other in the main-scanning cross section between the scanning start side and the scanning end side, in other words, asymmetric with respect to the optical axis.

TABLE 2

| | | Imaging optical element | | | |
|---|---|---|---|---|---|
| | | Incident | Incident | Exit | Exit |
| | | surface s | surface e | surface s | surface e |
| Gen- | R | 5.994.E+03 | | −6.341.E+01 | |
| era- | K | 7.779.E+00 | | −3.018.E−01 | |
| trix | B₃ | 2.172.E−05 | | 1.028.E−05 | |
| shape | B₄ | 1.039.E−05 | 1.106.E−05 | 1.275.E−05 | 1.202.E−05 |
| | B₆ | −4.537.E−08 | −4.577.E−08 | −2.205.E−08 | −2.183.E−08 |
| | B₈ | 5.652.E−11 | 5.652.E−11 | −5.659.E−12 | −5.659.E−12 |
| | B₁₀ | −2.583.E−14 | −2.583.E−14 | 1.714.E−14 | 1.714.E−14 |

| | | | |
|---|---|---|---|
| | B₁₂ | 0.000.E+00 | 0.000.E+00 |
| Sag- | R | −1.044.E+01 | −5.653.E+00 |
| ittal | E₁ | −9.738.E−04 | −4.891.E−04 |
| shape | E₂ | −1.307.E−04 | 3.588.E−06 |
| | E₄ | 2.735.E−06 | 5.721.E−07 |
| | E₆ | −8.350.E−09 | −5.657.E−10 |
| | E₈ | 6.917.E−12 | −1.444.E−12 |
| | E₁₀ | 0.000.E+00 | 0.000.E+00 |

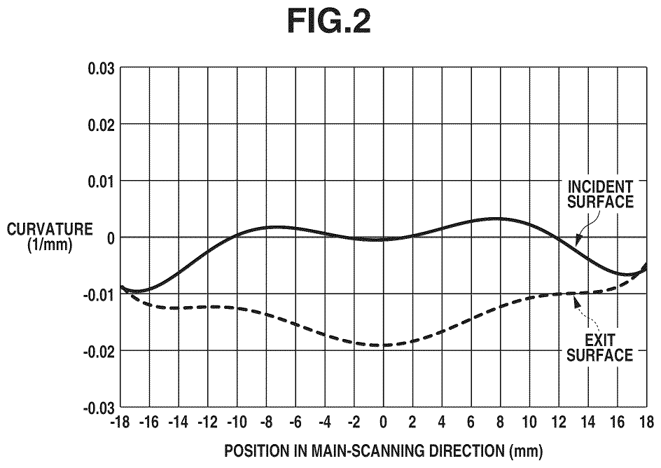

FIG. 2 is a graph indicating a curvature of each optical surface of the imaging optical element according to the present example in the main-scanning cross section on a position-by-position basis in the main-scanning direction. In the graph in FIG. 2, the vertical axis represents local curvatures of the imaging optical element in the main-scanning cross section, the horizontal axis represents positions in the main-scanning direction (the Y direction) relative to the optical axis (the X axis) serving as a reference. The solid line represents curvatures on the incident surface, and the dashed line represents curvatures on the exit surface. In FIG. 2, the positive sign of the curvature indicates that the center of curvature of the optical surface is on the +X side (the to-be-scanned surface 101 side) relative to the vertex of the optical surface serving as the reference. Conversely, the negative sign of the curvature indicates that the center of curvature of the optical surface is on the −X side (the deflector 105 side) relative to the vertex of the optical surface serving as the reference. A curvature at each position in the main-scanning direction of each optical surface can be calculated from the curvature radius at the local position on the optical surface, and thus can be calculated using the above-described aspheric equations.

As illustrated in FIG. 2, on the optical axis of the imaging optical element according to the present example, the signs of the curvatures of both the incident surface and the exit surface are negative, indicating that their respective centers of curvatures are positioned on the deflector 105 side. Thus, on the optical axis, the incident surface has a concave shape, the exit surface has a convex shape, and the imaging optical element has a meniscus shape. This facilitates the thinning of the central portion of the imaging optical element.

The curvature of the exit surface of the imaging optical element changes approaching zero (0) (i.e., the absolute value decreases) from the position on the optical axis to intermediate positions approximately ±10 mm away therefrom. In this manner, by maintaining a sufficient curvature in the proximity of the optical axis of the exit surface and reducing the absolute value of the curvature up to the intermediate image heights, the central portion of the imaging optical element can be thinned while a sufficient edge thickness is maintained. This facilitates both downsizing of the entire optical scanning apparatus 100 and manufacturing imaging optical elements.

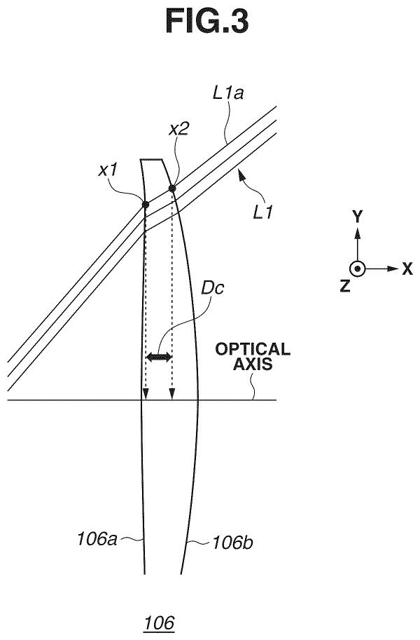

FIG. 3 is a partial enlarged view of the imaging optical system 106 (the imaging optical element) and the maximum off-axis light flux L1 in FIG. 1. In FIG. 3, an intersection point between a marginal ray (the maximum off-axis ray) L1a on the +Y side of the maximum off-axis light flux L1 and the incident surface of the imaging optical element is indicated as x1, and an intersection point between the marginal ray L1a on the +Y side and the exit surface of the imaging optical element as x2. A distance Dc between the intersection point x1 and the intersection point x2 in the X direction corresponds to a thickness (an edge thickness) on the maximum off-axis of the imaging optical element. From FIG. 3, it can be seen that the edge thickness Dc of the imaging optical element is approximately half the thickness on the optical axis, which means that a sufficient edge thickness can be maintained in the present example.

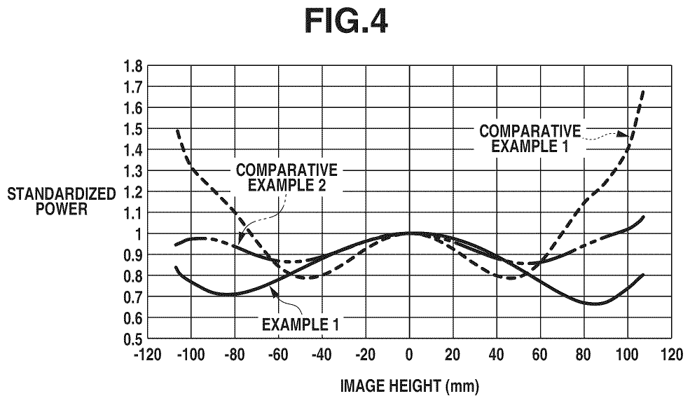

FIG. 4 is a graph indicating powers (refractive powers) of the imaging optical element according to the present example in the main-scanning cross section on a position-by-position basis in the main-scanning direction. In FIG. 4, to clarify the variation in the power of the imaging optical element in the main-scanning direction, values of off-axis power (standardized power) are shown in relation to image heights on the to-be-scanned surface 101 with the on-axis power set to 1. Thus, the standardized power herein represents a ratio (a power ratio) of the off-axis power to the power (the refractive power) on the optical axis. In FIG. 4, the vertical axis represents local standardized powers of the imaging optical element in the main-scanning cross section, while the horizontal axis represents image heights with respect to the optical axis (the X axis).

In the graph in FIG. 4, the solid line, the dashed line, and the two-dot chain line correspond to the present example, a comparative example 1, and a comparative example 2, respectively. The comparative examples 1 and 2 are based on the assumption of a configuration in which the imaging optical element alone is changed in the optical scanning apparatus 100 according to the present example. Specifically, the comparative example 1 is based on the assumption of the imaging optical element in a case where the constant-speed scanning method is applied to the optical scanning apparatus 100, and the comparative example 2 is based on the assumption of the imaging optical element so that the scanning speed of the optical scanning apparatus 100 monotonically increases from the on-axis image height to the maximum off-axis image heights.

As illustrated in FIG. 4, the standardized power of the imaging optical element according to the comparative example 1 significantly increases from the proximity of intermediate image heights which are half the maximum off-axis image heights, to the maximum off-axis image heights. In contrast, in the comparative example 2 using the variable-scanning speed method, the increases of the standardized power from the proximity of the intermediate image heights to the maximum off-axis image heights are reduced as compared with the comparative example 1. In the present example, since the image heights at which the standardized power starts to increase are significantly changed toward the corresponding maximum off-axis image heights as compared with the comparative example 2, the standardized power is significantly reduced in the proximity of the maximum off-axis image heights. This configuration makes it possible to maintain a sufficient edge thickness while the central portion of the imaging optical element is thinned as compared with the comparative examples 1 and 2.

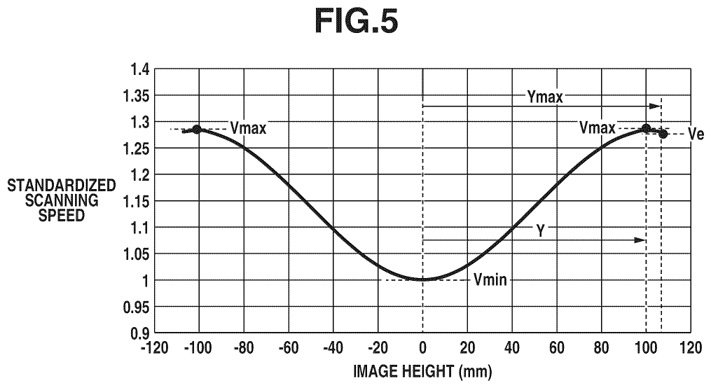

FIG. 5 is a graph indicating the scanning speed to perform scanning with a light flux at each image height on the to-be-scanned surface 101. In FIG. 5, the vertical axis represents scanning speeds (standardized scanning speeds) at off-axis image heights with the scanning speed at the on-axis image height set to 1, while the horizontal axis represents image heights relative to the optical axis (the X axis) serving as a reference.

Thus, a standardized scanning speed indicates the ratio of the scanning speed at an off-axis image height to the scanning speed at the on-axis image height (a scanning speed ratio). In other words, a scanning speed ratio corresponds to the ratio of an off-axis partial magnification to an on-axis partial magnification (a partial magnification ratio) of the imaging optical system 106.

As illustrated in FIG. 5, the standardized scanning speed in the present example becomes a minimum value (and a local minimum value) at the on-axis image height Y0 (an image height of 0 mm), and a maximum value (and a local maximum value) at the intermediate image height Y (an image height of 101 mm). In other words, in the present example, the standardized scanning speed at the maximum off-axis image height Ymax is neither the minimum value nor the maximum value. In this manner, the configuration in which the scanning speed reaches the maximum value at an image height lower than the maximum off-axis image height makes it possible to reduce increase in a spot diameter in the proximity of the maximum off-axis image heights. As a result, compared with a configuration in which the scanning speed monotonically increases from the on-axis image height to the maximum off-axis image heights, better print performance can be achieved.

A second example will now be described. An optical scanning apparatus 100 according to the present example will be described. The optical scanning apparatus 100 according to the present example is different from the above-described optical scanning apparatus 100 according to the first example in the shape and the arrangement of the imaging optical element. The configuration other than these is the same as that in the first example, and the description thereof will thus be omitted.

Table 3 shows a shape of each optical surface of the imaging optical element according to the present example.

TABLE 3

| | | Imaging optical element | | | |
|---|---|---|---|---|---|
| | | Incident | Incident | Exit | Exit |
| | | surface s | surface e | surface s | surface e |
| Gen- | R | −1.785.E+02 | | −4.776.E+01 | |
| era- | K | 3.146.E+00 | | 1.686.E+00 | |
| trix | B₃ | 2.074.E−05 | | 9.116.E−06 | |
| shape | B₄ | 1.103.E−05 | 1.170.E−05 | 1.400.E−05 | 1.327.E−05 |
| | B₆ | −5.361.E−08 | −5.401.E−08 | −2.749.E−08 | −2.726.E−08 |
| | B₈ | 1.003.E−10 | 1.003.E−10 | 2.959.E−11 | 2.959.E−11 |
| | B₁₀ | −8.588.E−14 | −8.588.E−14 | −1.850.E−14 | −1.850.E−14 |

| | | | |
|---|---|---|---|
| | B₁₂ | 0.000.E+00 | 0.000.E+00 |
| Sag- | R | −8.758.E+00 | −5.394.E+00 |
| ittal | E₁ | −1.748.E−03 | −7.696.E−04 |
| shape | E₂ | −2.868.E−04 | −5.479.E−05 |
| | E₄ | 2.714.E−06 | −1.418.E−07 |
| | E₆ | −7.761.E−09 | 1.811.E−09 |
| | E₈ | 5.363.E−12 | −4.702.E−12 |
| | E₁₀ | 0.000.E+00 | 0.000.E+00 |

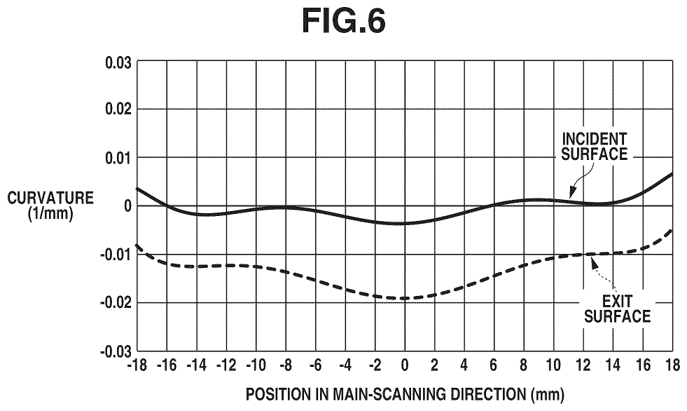

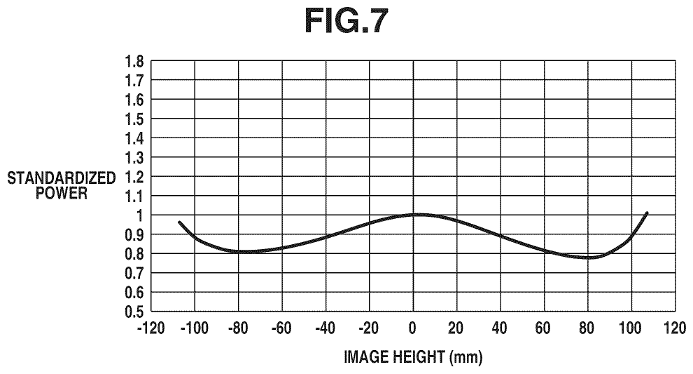

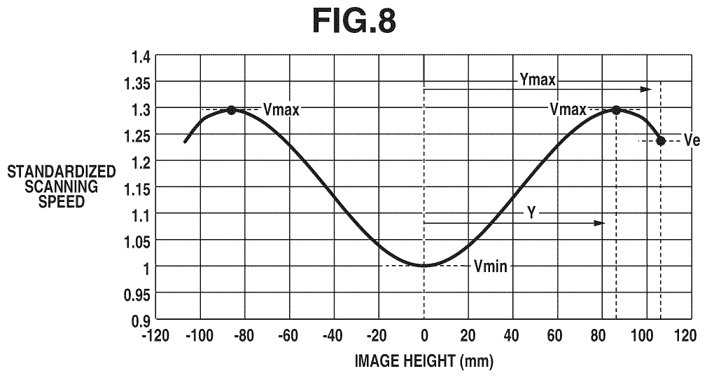

FIG. 6 illustrates change in curvature of each optical surface of the imaging optical element according to the present example in the main-scanning cross section similarly to FIG. 2. Additionally, FIG. 7 illustrates change in the standardized power of the imaging optical element according to the present example similarly to FIG. 4. Furthermore, FIG. 8 illustrates change in the standardized scanning speed on the to-be-scanned surface 101 similarly to FIG. 5. Similarly to the first example, the incident surface has a concave shape, the exit surface has a convex shape, and the imaging optical element has a meniscus shape on the optical axis of the imaging optical element according to the present example. The curvature of the exit surface of the imaging optical element changes approaching zero (0) from the position on the optical axis to intermediate positions approximately ±10 mm away therefrom. Furthermore, the image heights at which the standardized power of the imaging optical element starts to increase are positioned sufficiently close to the corresponding maximum off-axis image heights.

As illustrated in FIG. 8, in the present example, the positions of the intermediate image heights at which the scanning speeds become the maximum values Vmax are close to the position of the on-axis image height Y0 as compared with the first example. Thus, the scanning speed Ve at the maximum off-axis image height is lower than that in the first example. In contrast, as illustrated in FIG. 7, the imaging optical element according to the present example is configured so that the standardized power at the maximum off-axis image heights are larger than those in the first example. This makes it possible to maintain a sufficient edge thickness while the central portion of the imaging optical element is thinned.

A third example will now be described. An optical scanning apparatus 100 according to the present example will be described. The optical scanning apparatus 100 according to the present example is different from the above-described optical scanning apparatuses 100 according to the first and second examples in the shape and the arrangement of the imaging optical element. The configuration other than these is the same as that in the first example, and the description thereof will thus be omitted.

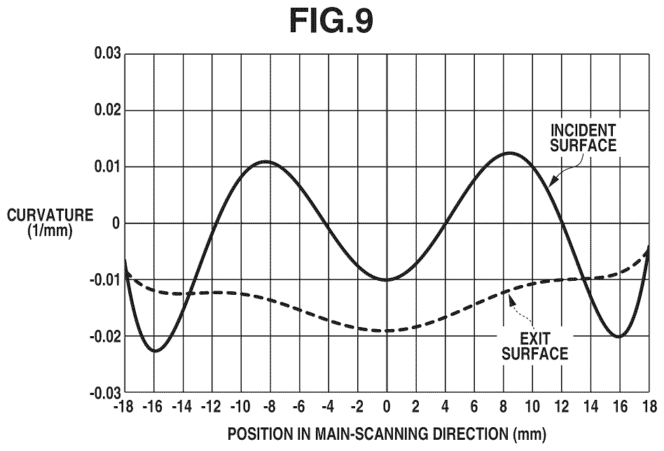

Table 4 indicates a shape of each optical surface of the imaging optical element according to the present example. FIG. 9 illustrates change in curvature of each optical surface of the imaging optical element according to the present example in the main- scanning cross section similarly to FIG. 2.

TABLE 4

| | | Imaging optical element | | | |
|---|---|---|---|---|---|
| | | Incident | Incident | Exit | Exit |
| | | surface s | surface e | surface s | surface e |
| Gen- | R | −9.926.E+01 | | −3.873.E+01 | |
| era- | K | −3.403.E+00 | | −5.159.E+00 | |
| trix | B₃ | 2.014.E−05 | | 8.307.E−06 | |
| shape | B₄ | 5.733.E−05 | 5.800.E−05 | 3.372.E−05 | 3.299.E−05 |
| | B₆ | −2.219.E−07 | −2.223.E−07 | −5.926.E−08 | −5.903.E−08 |
| | B₈ | 3.082.E−10 | 3.082.E−10 | −8.004.E−11 | −8.004.E−11 |
| | B₁₀ | −1.093.E−13 | −1.093.E−13 | 1.780.E−13 | 1.780.E−13 |

| | | | |
|---|---|---|---|
| | B₁₂ | 0.000.E+00 | 0.000.E+00 |
| Sag- | R | −9.483.E+00 | −5.588.E+00 |
| ittal | E₁ | −1.368.E−03 | −6.455.E−04 |
| shape | E₂ | −4.653.E−04 | −1.630.E−04 |
| | E₄ | 6.620.E−06 | 1.737.E−06 |
| | E₆ | −2.074.E−08 | −2.579.E−09 |
| | E₈ | 1.808.E−11 | −1.552.E−12 |
| | E₁₀ | 0.000.E+00 | 0.000.E+00 |

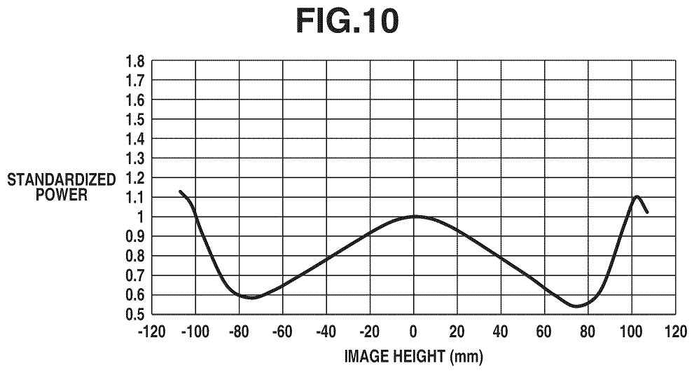

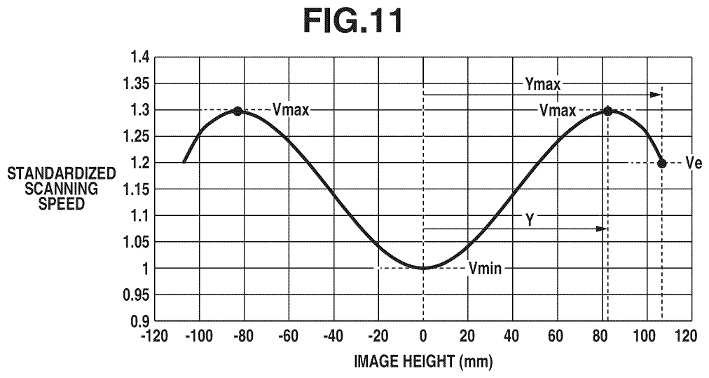

FIG. 9 illustrates change in curvature of each optical surface of the imaging optical element according to the present example in the main-scanning cross section similarly to FIG. 2. Additionally, FIG. 10 illustrates change in the standardized power of the imaging optical element according to the present example similarly to FIG. 4. Furthermore, FIG. 11 illustrates change in the standardized scanning speed on the to-be-scanned surface 101 similarly to FIG. 5. Similarly to the first and second examples, the incident surface has a concave shape, the exit surface has a convex shape, and the imaging optical element has a meniscus shape on the optical axis of the imaging optical element according to the present example. The curvature of the exit surface of the imaging optical element changes approaching zero (0) from the position on the optical axis to intermediate positions approximately ±10 mm away therefrom. Furthermore, the image heights at which the standardized power of the imaging optical element starts to increase are positioned sufficiently close to the corresponding maximum off-axis image heights.

As illustrated in FIG. 11, in the present example, the positions of the intermediate image heights at which the scanning speeds become the maximum value Vmax are close to the position of the on-axis image height Y0 as compared with the second example. Thus, the scanning speed Ve at the maximum off-axis image height is lower than that in the second example. In contrast, as illustrated in FIG. 10, the imaging optical element according to the present example is configured so that the standardized powers at the maximum off-axis image heights are larger than those in the second example 2. This makes it possible to maintain a sufficient edge thickness while the central portion of the imaging optical element is thinned.

Table 5 indicates intermediate values in the inequalities (1) to (3) in the above-described examples.

TABLE 5

| | | | Example 1 | Example 2 | Example 3 |
|---|---|---|---|---|---|
| | Y | (mm) | 101.30 | 86.90 | 83.50 |
| | Ymax | (mm) | 107.00 | 107.00 | 107.00 |
| | Ve | | 1.280 | 1.230 | 1.200 |
| | Vmax | | 1.283 | 1.296 | 1.297 |
| | Vmin | | 1.000 | 1.000 | 1.000 |
| | Dc | (mm) | 2.70 | 2.75 | 2.70 |
| | Do | (mm) | 5.40 | 5.40 | 5.40 |
| Inequality (1) | Y/Ymax | | 0.947 | 0.812 | 0.780 |
| Inequality (2) | Ve/Vmax | | 0.998 | 0.949 | 0.925 |
| Inequality (3) | Vmax/Vmin | | 1.283 | 1.296 | 1.297 |
| Inequality (4) | Dc/Do | | 0.50 | 0.51 | 0.50 |

### [Image Forming Apparatus]

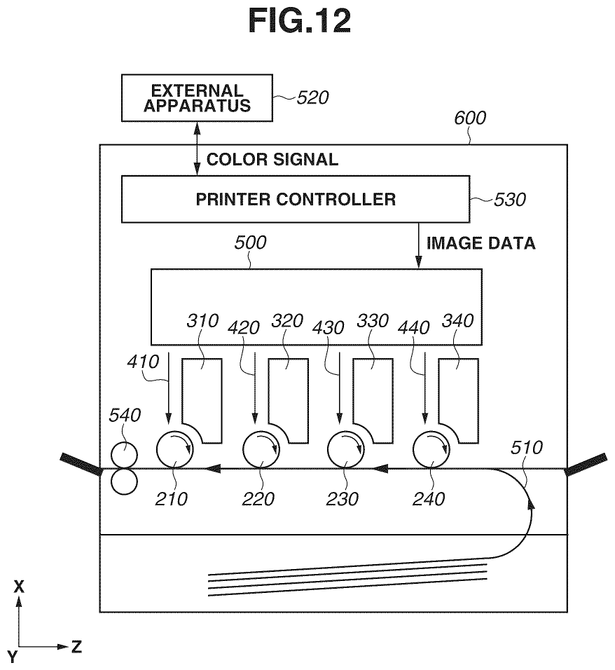

FIG. 12 is a schematic diagram (a ZX cross-sectional view) illustrating a main portion of an image forming apparatus 600 according to the present exemplary embodiment. The image forming apparatus 600 is a tandem full-color image forming apparatus that records image information on photosensitive surfaces (scanned surfaces) of four photosensitive drums (photosensitive members) in parallel with each other using an optical scanning unit 500.

The image forming apparatus 600 includes a printer controller (control unit) 530, an optical scanning unit 500, photosensitive drums 210, 220, 230, and 240 as image bearing members, developing apparatuses 310, 320, 330, and 340, a conveyance belt 510, and a fixing unit 540. The optical scanning unit 500 can employ a configuration including four optical scanning apparatuses according to any one of the first to the third examples described above. In this case, the optical scanning unit 500 is disposed such that the sub-scanning direction matches the Z-direction as the rotational direction of each of the photosensitive drums 210, 220, 230, and 240.

As illustrated in FIG. 12, color signals of red (R), green (G), and blue (B) are output from an external device 520, such as a personal computer. The color signals are converted into respective image signals (image data or dot data) of yellow (Y), magenta (M), cyan (C), and black (K) by the printer controller 530 and are input to the optical scanning unit 500. The printer controller 530 performs the above-described conversion of the signals, as well as the control of each unit of the image forming apparatus 600, such as a motor, which will be described in the following.

The optical scanning unit 500 scans the photosensitive surfaces of the photosensitive drums 210, 220, 230, and 240 in the main-scanning direction (the Y direction) with light fluxes 410, 420, 430, and 440, respectively, all of which are modulated according to respective pieces of image data. The photosensitive drums 210, 220, 230, and 240 are rotated clockwise by a non-illustrated motor, and those rotations move the photosensitive surfaces in the sub-scanning direction (the Z direction) with respect to the light fluxes 410, 420, 430, and 440. The photosensitive surfaces charged by not-illustrated charging rollers are exposed to the respective light fluxes 410, 420, 430, and 440, and thus electrostatic latent images are formed on the respective photosensitive surfaces.

Thereafter, the electrostatic latent images formed on the photosensitive surfaces of the photosensitive drums 210, 220, 230, and 240 corresponding to the respective colors are developed as toner images in the respective colors by developing apparatuses 310, 320, 330, and 340. The toner images in the respective colors are multi-transferred to a material to be transferred that is conveyed by the conveyance belt 510, and then are subjected to fixing by the fixing unit 540. As a result of the above-described process, one full-color image is formed.

The optical scanning unit 500 can employ, for example, a configuration in which two optical scanning apparatuses that simultaneously scan two to-be-scanned surfaces using a single deflector are disposed or a configuration in which one optical scanning apparatus that simultaneously scans four to-be-scanned surfaces using a single deflector is disposed. Additionally, a full-color digital copy machine can be configured with a full-color image reading apparatus as the external device 520 including a line sensor, such as a charge-coupled device (CCD) sensor or a complementary metal-oxide semiconductor (CMOS) sensor, connected to the image forming apparatus 600. Alternatively, a monochrome image forming apparatus can be configured by employing the optical scanning unit 500 consisting of a single optical scanning apparatus.

While the description has been given of the exemplary embodiment and the examples, the disclosure is not limited to those exemplary embodiment and examples, and the various combinations, modifications, and changes can be made within the scope of the disclosure.

For example, the optical scanning apparatus 100 according to the present exemplary embodiment can include a synchronization detection unit used for determining a scanning start position (a position at which an image is written) on the to-be-scanned surface 101. A light-receiving unit (a sensor) that receives light fluxes deflected by the deflector 105 can be employed as the synchronization detection unit. The control unit controls a light emission timing of the light source 102 based on an output (a signal) from the light-receiving unit to determine a scanning start position on the to-be-scanned surface 101. With the synchronization detection unit employed, a light-receiving element in the light-receiving unit can be disposed on a substrate provided with the light-emitting element of the light source 102.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-085798, filed May 27, 2024, which is hereby incorporated by reference herein in its entirety.

What is claimed is:

1. A scanning apparatus comprising:
a deflector configured to deflect a light flux from a light source to scan a surface with the light flux in a main-scanning direction; and
an optical system configured to guide the light flux deflected by the deflector to the surface to be scanned,
a scanning speed to scan the surface to be scanned with the light flux is a variable speed, and
wherein the following inequality is satisfied:
$$0.7 \leq \vert Y \vert / \vert Ymax \vert < 1. 00 ,$$
where on the surface to be scanned, |Ymax| is an absolute value of a maximum off-axis image height and |Y| is an intermediate image height at which the scanning speed is maximum.

2. The scanning apparatus according to claim 1, wherein the scanning speed at the maximum off-axis image height is higher than the scanning speed at an on-axis image height.

3. The scanning apparatus according to claim 1, wherein the scanning speed monotonically changes between the intermediate image height and the on-axis image height and between the intermediate image height and the maximum off-axis image height.

4. The scanning apparatus according to claim 3, wherein the scanning speed monotonically increases from the on-axis image height to the intermediate image height, and monotonically decreases from the intermediate image height to the maximum off- axis image height.

5. The scanning apparatus according to claim 1, wherein an optical element included in the optical system is a single optical element.

6. The scanning apparatus according to claim 5, wherein on an optical axis, an incident surface of the optical element has a concave shape, and an emitting surface of the optical element has a convex shape.

7. The scanning apparatus according to claim 1, further comprising an optical element configured to convert convergence of the light flux from the light source, wherein a refractive power of the optical element is different between a main-scanning cross section and a sub-scanning cross section from each other.

8. The scanning apparatus according to claim 7, wherein the optical element is disposed closer to the deflector than a front principal surface of the optical element.

9. The scanning apparatus according to claim 1, wherein the optical system includes an optical element including an optical surface that changes in curvature in a main-scanning cross section in a main-scanning direction.

10. The scanning apparatus according to claim 9, wherein an absolute value of the curvature of the optical surface in the main-scanning cross section approaches zero (0) with increasing distance from an optical axis in the main-scanning direction.

11. The scanning apparatus according to claim 1, wherein the following inequality is satisfied:
$$0.85 \leq Ve / Vmax < 1. 00 ,$$
where Vmax is a maximum value of the scanning speed and Ve is the scanning speed at the maximum off-axis image height.

12. The scanning apparatus according to claim 1, wherein the following inequality is satisfied:
$$1.1 \leq Vmax / Vmin < 1.40 ,$$
where Vmin is a minimum value of the scanning speed and Vmax is a maximum value of the scanning speed.

13. The scanning apparatus according to claim 1, wherein the following inequality is satisfied:
$$0.46 \leq Dc / Do \leq 0.60 ,$$
where Do is a thickness of an optical element included in the optical system on an optical axis and Dc is a thickness of the optical element at a position through which a maximum off-axis ray passes.

14. A forming apparatus comprising:
the scanning apparatus according to claim 1; and
a developing apparatus configured to develop an electrostatic-latent image formed by using the scanning apparatus on the surface to be scanned as a toner image.

15. A forming apparatus comprising:
the scanning apparatus according to claim 1; and
a controller configured to convert data output from an external device into an image signal and input the image signal to the scanning apparatus.
